(19) United States
(12) Patent Application Publication
(10) Pub. No.: US 2010/0250693 A1
(43) Pub. Date: Sep. 30, 2010

(54) METHOD, APPARATUS FOR CONVERTING GROUP MESSAGE AND SYSTEM FOR EXCHANGING GROUP MESSAGE

(75) Inventors: Zhihao Zheng, Shenzhen City (CN); Ying Wang, Shenzhen City (CN)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: Tencent Technology (Shenzhen) Company Ltd., Shenzhen (CN)

(21) Appl. No.: 12/813,065

(22) Filed: Jun. 10, 2010

Related U.S. Application Data
(63) Continuation of application No. PCT/CN2008/007332, filed on Dec. 3, 2008.

(30) Foreign Application Priority Data
Dec. 29, 2007 (CN) 200710160699.8

(51) Int. Cl. G06F 15/16

(52) U.S. Cl. 709/206; 709/204

(57) ABSTRACT

The present invention provides an apparatus and method for converting group message and a group message exchanging system. The apparatus includes: a parsing unit, adapted to obtain a group identifier of group communication information of a first type; a member information obtaining unit, adapted to obtain an address of each of at least one group member of a group for communicating group communication information of a second type according to the group identifier obtained; and a converting unit, adapted to convert the group communication information of the first type into the group communication information of the second type according to the address for communicating the group communication information of the second type obtained. The apparatus, method and system provided by the present invention enable information exchanging between different network communication systems.

### FIELD OF THE INVENTION

The present invention relates to Internet communication techniques, and particularly, to method, apparatus for converting group message and system for exchanging group messages.

### BACKGROUND OF THE INVENTION

Network communication systems refer to systems based on the Internet and provide communication services to users, such as Instant Messaging (IM) systems, Email systems, online game systems, online forum systems, etc. Different network communication systems may adopt different communication modes.

IM service is one of communication services based on the Internet. It mainly provides online instant communications. An IM tool refers to a client for providing the IM service. For example, an IM tool may be a software program installed in a wireless terminal such as a cell phone, or an IM program installed in a computer, or a client embedded in a webpage which provides the IM service for a user after the user logs on via the webpage. IM tools have been widely used and accepted throughout the Internet due to the convenience and flexibility.

Email service is also a type of communication service based on the Internet. People may exchange information and discuss questions through emails conveniently and quickly.

With the development of the Internet, group communication becomes a new communication manner in network communication systems. For example, in an IM system, besides instant communications between two users via point-to-point techniques, users having the same hobby or the same characteristics may form a group and communicate with each other. Generally, all members of the group have the same concern or a common topic. Other users who concern the same or are interested in the same topic may join the group to become a group member. When a group member speaks, other members can receive a group instant message transmitted by the member. Thus, multiple users may have a discussion about a same topic. For example, classmates may apply for joining a group of their class. For another example, a person interested in the science of law may apply for joining a “law” group.

Meanwhile, with users' requirements for email services becoming diversified, most email providers begin to provide group email services. A group email service may be integrated into diversified application systems, e.g. an IM system, an online game system or an online forum system, so that users having the same hobby or of the same characteristic in the application system may participate in a series of group emails of the same topic and effectively communicate with each other through the group emails.

At present, the IM system provides the group communication service only through group chat functions of an IM client after a user starts the IM client and logs on from the IM client. The email system provides group communication service only through group email functions of an email client associated with an application system after a user starts and logs on from the email client. The email client refers to a tool capable of providing email functions for users, including software installed in a wireless terminal such as a cell phone, a software application installed into a computer, a client in a webpage supporting sending/receiving an email a user who logged on via the webpage. Since the above two systems have respective types of client, there is a problem that: the IM system and the email system can not exchange group communication information with each other.

For example, when a user chats with other group members through a group chat window of an IM system, if someone sends an email to the group, the user cannot receive an immediate notification of the incoming email and therefore cannot learn contents of the email right away. The user has to start an email client associated with the IM system and logs on through the email client to view and reply to the email through functions provided by the email client. Similarly, if the user can only log on via an email client but cannot log on via an IM client for some reasons, the user cannot obtain group chat information from an IM system and therefore cannot chat with other group members.

In view of the above, in the prior art, different network communication systems, such as the IM system and the email system, cannot exchange group communication information, which is inconvenient for users communicating online.

### SUMMARY OF THE INVENTION

Embodiments of the present invention provide an apparatus and method for converting group message and a group message exchanging system, so as to enable group message exchanging between different network communication systems, such as between an Instant Messaging (IM) system and an email system.

According to an embodiment of the present invention, an apparatus for converting group message is provided. The apparatus includes:

a parsing unit, adapted to obtain a group identifier of group communication information of a first type;

a member information obtaining unit, adapted to obtain, according to the group identifier obtained, an address of each of at least one group member of a group for communicating group communication information of a second type; and

a converting unit, adapted to convert the group communication information of the first type into group communication information of the second type according to the address for communicating group communication information of the second type.

According to another embodiment of the present invention, a method for converting group message is provided. The method includes:

obtaining a group identifier of received group communication information of a first type;

obtaining, according to the group identifier, an address of each of at least one group member of a group for communicating group communication information of a second type; and

converting the group communication information of the first type into group communication information of the second type according to the address for communicating group communication information of the second type and sending the converted group communication information of the second type.

According to yet another embodiment of the present invention, a group message exchanging system is provided. The system includes:

a group email converting apparatus, adapted to receive a first group instant message and convert the first group instant message into a first group email and send the first group email; and

a group message converting apparatus, adapted to receive a second group email, convert the second group email into a second group instant message and send the second group instant message.

It can be seen from the above technical solution that, compared with the prior art, the apparatus, method for converting group message and the group message exchanging system provided by the embodiments of the present invention are able to convert different types of group communication information and transmit the converted group communication information to the group members. For example, it is possible to convert a group instant message of an IM system into a group email of an email system and transmit the group email converted from the group instant message. For another example, it is also possible to convert a group email of an email system into a group instant message of an IM system and transmit the group instant message converted from the group email. Thus, the problem that different network communication systems (such as IM system, network game system, network forum system, email system, etc.) cannot exchange group communication information can be solved.

### BRIEF DESCRIPTION OF THE DRAWINGS

FIG. 1 is a schematic illustrating a structure of a group mail converting apparatus for converting a group instant message into a group email in accordance with an embodiment of the present invention.

FIG. 2 is a flowchart illustrating a group mail converting method in accordance with an embodiment of the present invention.

FIG. 3 is a schematic illustrating a structure of a group mail converting apparatus in accordance with embodiment one of the preset invention.

FIG. 4 is a flowchart illustrating a group mail converting method in accordance with embodiment one of the present invention.

FIG. 5 is a schematic diagram illustrating a structure of a group mail converting apparatus in accordance with embodiment two of the preset invention.

FIG. 6 is a flowchart illustrating a group mail converting method in accordance with embodiment two of the present invention.

FIG. 7 is a schematic illustrating a structure of a group mail converting apparatus in accordance with embodiment three of the preset invention.

FIG. 8 is a flowchart illustrating a group mail converting method in accordance with embodiment three of the present invention.

FIG. 9 is a schematic illustrating a structure of a group mail converting apparatus in accordance with embodiment four of the preset invention.

FIG. 10 is a flowchart illustrating a group mail converting method according to embodiment four of the present invention.

FIG. 11 is a schematic illustrating a structure of a group message converting apparatus for converting a group email into a group instant message in accordance with an embodiment of the present invention.

FIG. 12 is a flowchart illustrating a group message converting method in accordance with an embodiment of the present invention.

FIG. 13 is a schematic diagram illustrating a group message converting apparatus in accordance with a fifth embodiment of the present invention.

FIG. 14 is a flowchart illustrating a group message converting method in accordance with embodiment five of the present invention.

FIG. 15 is a schematic illustrating a group instant message converted by the method shown in FIG. 14.

FIG. 16 is a block diagram illustrating a structure of group message exchanging network in accordance with an embodiment of the present invention.

FIG. 17 is a block diagram illustrating an internal structure of a group message exchanging system in accordance with an embodiment of the present invention.

### DETAILED DESCRIPTION OF THE INVENTION

The present invention will be described in detail hereinafter with reference to embodiments and accompanying drawings to make the technical scheme and merits therein clearer.

Embodiments of the present invention provide a group message converting apparatus for converting different types of group communication information, and provide a group message exchanging system and a method for converting group message. The technical scheme provided enables group members to exchange group communication information even when they access the network via different types of clients.

In an embodiment of the present invention, the group message converting apparatus may convert a group instant message into a group email so as to transport information from an IM system to an email system. The above group message converting apparatus is also referred to as a group email converting apparatus.

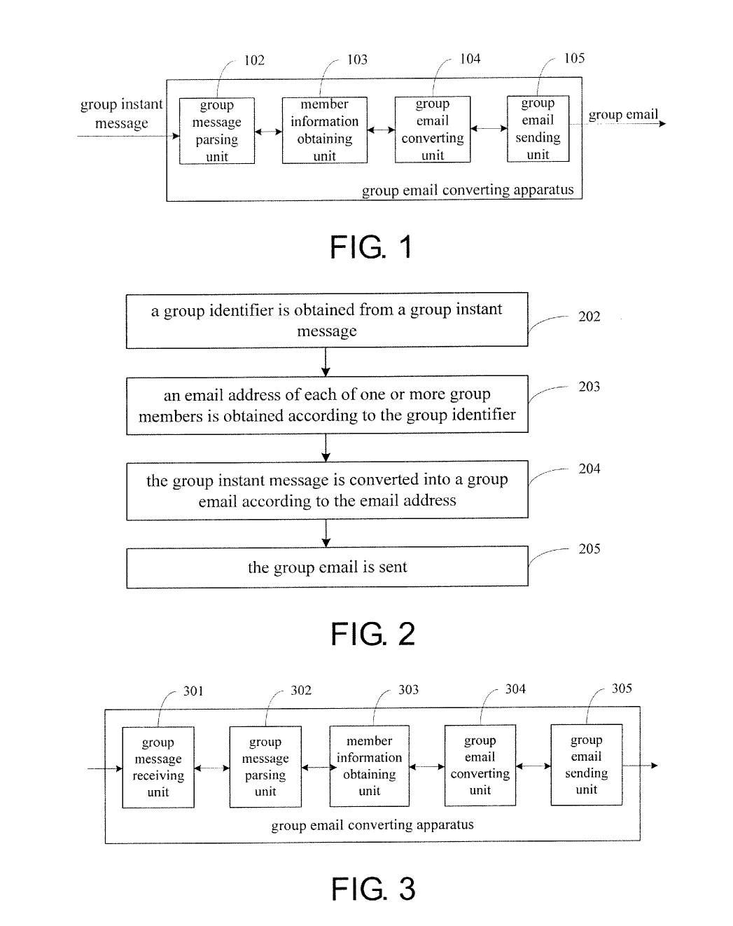

FIG. 1 is a schematic diagram illustrating a structure of a group email converting apparatus in accordance with an embodiment of the present invention. As shown in FIG. 1, the apparatus obtains a group identifier of a group instant message from the group instant message sent by an IM system, obtains an email address of each group member according to the group identifier, converts the group instant message into a group email and sends the group email.

As shown in FIG. 1, the apparatus includes: a group message parsing unit 102, a member information obtaining unit 103 and a group email converting unit 104.

The group message parsing unit 102 is adapted to obtaining a group identifier from a group instant message.

The member information obtaining unit 103 is adapted to obtain email address of each group member according to the group identifier obtained by the group message parsing unit 102.

The group email converting unit 104 is adapted to convert the group instant message into a group email according to the email address obtained by member information obtaining unit 103.

The apparatus may further include: a group email sending unit 105, adapted to transmit the group email generated by the group email converting unit 104 to group members.

FIG. 2 is a flowchart illustrating a group email converting method in accordance with an embodiment of the present invention. As shown in FIG. 2, the method may include steps as follows.

In step 202, a group identifier of a group instant message is obtained.

In step 203, an email address of each of one or more group members is obtained according to the group identifier. Specifically, an IM ID of each group member may be obtained according to the group ID. Since the email system is associated with the IM system, the email address of each group member may be obtained through the IM ID of the group member.

In step 204, the group instant message is converted into a group email according to the email address.

In step 205, the group email is sent.

The group email converting apparatus and method will be described in detail hereinafter with reference to embodiments.

### Embodiment One

FIG. 3 is a schematic diagram illustrating a group email converting apparatus in accordance with embodiment one of the present invention. As shown in FIG. 3, the apparatus receives a group instant message from a user via an IM server, obtains from the group instant message information including a group ID, an sender IM ID, sending time and message contents, obtains an email address of each group member according to the group ID, converts the group instant message into a group email, and sends the group email to an email server.

As shown in FIG. 3, the apparatus may include: a group message receiving unit 301, a group message parsing unit 302, a member information obtaining unit 303, a group email converting unit 304 and a group email sending unit 305.

The group message receiving unit 301 is adapted to receive a group instant message from a user of an IM system.

The group message parsing unit 203 is adapted to parse the group instant message received by the group message receiving unit 301 and to obtain from the group instant message at least one of a group ID, an sender IM ID, sending time and message contents.

The member information obtaining unit 303 is adapted to search group data stored in a system database according to the group ID obtained by the group message parsing unit 302 to obtain an email address of each group member.

The group email converting unit 304 is adapted to take the email address of each group member obtained by the member information obtaining unit 303 as a recipient address of the group email, and take the group ID, the sender IM ID, the sending time and the message contents obtained by the group message parsing unit 302 as contents of the group email to form a group email with one or more recipients.

The group email sending unit 305 is adapted to send the group email generated by the group email converting unit 304 to an email system. Then, the email system may send the group email to each user specified by each recipient address.

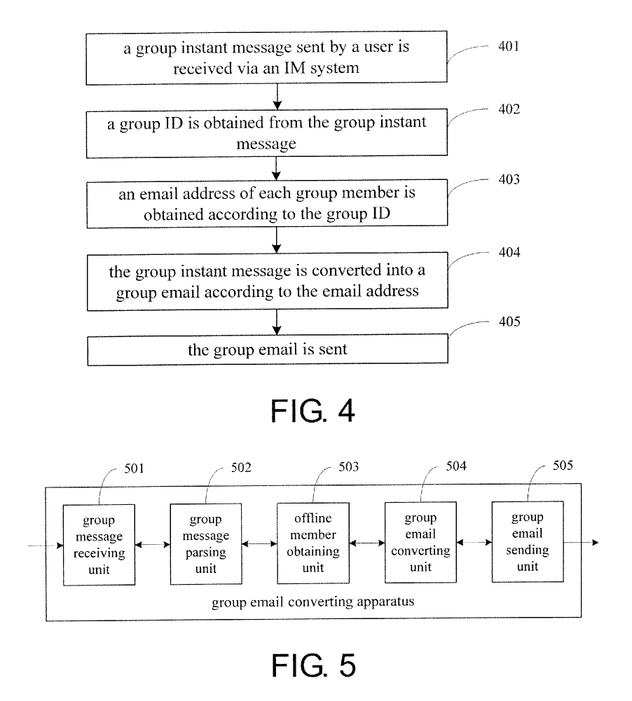

FIG. 4 is a flowchart illustrating a group email converting method in accordance with embodiment one of the present invention. As shown in FIG. 4, the method may include steps as follows.

In step 401, a group instant message sent by a user is received via an IM system.

When the user in a group sends the group instant message to other group members through the IM system, an IM server establishes a connection between the user and other online group members, transmits the group instant message to the other online group members and stores the group instant message in the IM server for offline users (or non-online users). The connection may be established in a direct connection manner or a server forwarding manner. The process is similar to that in existing IM systems and thus will not be described in detail herein.

The IM server also transmits the group instant message to the group email converting apparatus of this embodiment. Therefore, the group email converting apparatus may receive the group instant message sent by the user.

In step 402, at least one of a group ID, a sender IM ID, sending time and message contents are obtained from the group instant message received from the IM system.

After receiving the group instant message from the IM system, the group email converting apparatus parses the group instant message, and obtains from the group instant message information included in the group instant message, such as the group ID, the sender IM ID, the sending time and the message contents and so on.

In step 403, an email address of each group member is obtained according to the group ID obtained from the group instant message.

The group email converting apparatus searches group data stored in a system database based on the group ID obtained for an IM ID of each group member. Furthermore, the group email converting apparatus searches user data stored in the system database according to the IM ID of each group member to obtain an email address of each group member.

It should be noted that, when a user registers in the IM system, the IM system will allocate an IM ID to the user. When the IM system is associated with an email system, the IM system will further allocate an email address to the user. The IM ID is solely associated with the email address. The system database will store user data for the user, including user personal information (such as nickname, age, address, etc.), the IM ID and associated email address.

In addition, the user may register a group with a subject which shows the concern of the user. The IM system will allocate a group ID to the group. Other users may apply for joining in the group as group members if they are interested in the subject of the group. In the system database, corresponding group data including group ID, member information (such as IM ID, etc.) of the group will be stored for the group.

In step 404, the group instant message is converted into a group email according to the email address.

The group email converting apparatus forms a group email utilizing the information such as the group ID, the sender IM ID, the sending time and the message contents etc. obtained in step 402 as contents of the group email, and fills the recipient address field of the group email with the email address of each group member obtained in step 403.

In step 405, the group email is sent to an email server.

The group email converting apparatus sends the group email to the email server. The email server then sends the group email to each group member according to the recipient address.

It can be seen from the above that, only the group ID is required for obtaining the email address. Thus, it is unimportant which of the step of obtaining at least one of the sender IM ID, the sending time and the message contents and the step of obtaining the email address is performed ahead of the other, and the two steps can be performed simultaneously.

In this embodiment, a group instant message in an IM system is converted into a group email of an email system, and the group email is transmitted to members of the group. As such, the IM system is enabled transfer information to the email system.

### Embodiment Two

Based on embodiment one, online/offline state of each group member in an IM system is further acquired. And the group email converted from the group instant message will be sent only to offline members.

FIG. 5 is a schematic diagram illustrating a group email converting apparatus in accordance with embodiment two of the present invention. As shown in FIG. 5, the apparatus receives a group instant message sent by a user of an IM system, obtains from the group instant message a group ID, a sender IM ID, sending time and message contents, obtains an email address of each offline group member according to the group ID, converts the group instant message into a group email, take each offline member as a recipient of the group email and transmits the group email to an email server.

It can be seen from FIG. 5 that, based on embodiment one, the apparatus of this embodiment may include: a group message receiving unit 501, a group message parsing unit 502, an offline member obtaining unit 503, a group email converting unit 504 and a group email sending unit 505.

The group message receiving unit 501 and the group message parsing unit 502 have the same functions as the group message receiving unit 301 and the group message parsing unit 302 of embodiment one.

The offline member obtaining unit 503 is adapted to acquire online/offline state of each group member in the IM system, search group data stored in a system database to obtain an email address of each offline group member.

The group email converting unit 504 has the same function as the group email converting unit 304 of embodiment one. The group email converting unit 504 is adapted to take the email address of each offline group member obtained by the offline member obtaining unit 503 as a recipient address of the group email, and form the group email using the group ID, the sender IM ID, the sending time and the message contents obtained by the group message parsing unit 502 as contents of the group email.

The group email sending unit 505 has the same function as the group email sending unit 305 of embodiment one. The group email sending unit 505 is adapted to transmit the group email generated by the group email converting unit 504 to an email server. The email server transmits the group email to each group member.

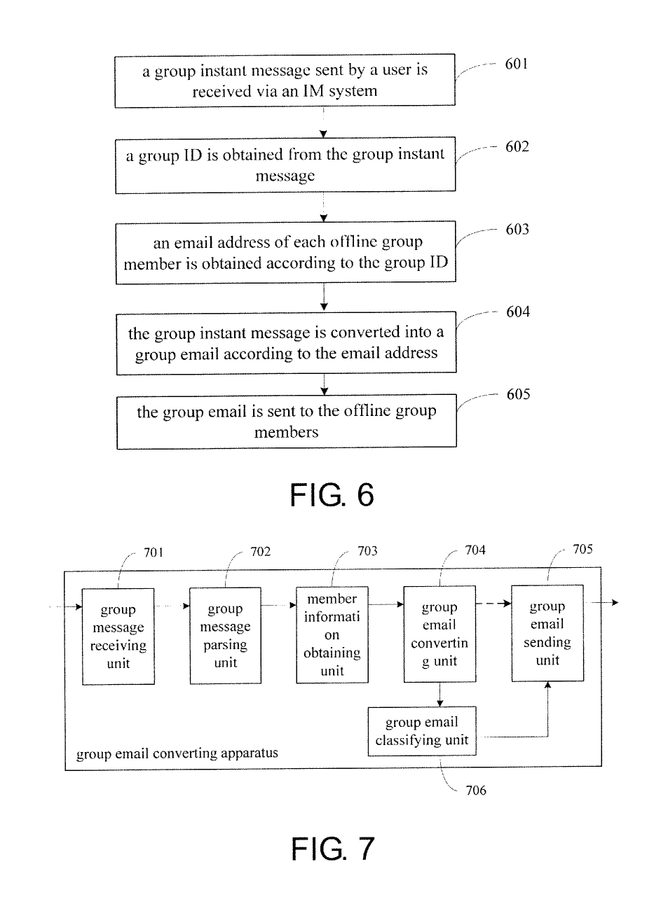

FIG. 6 is a flowchart illustrating a group email converting method in accordance with embodiment two of the present invention. As shown in FIG. 6, the method may include the steps as follows.

In step 601, a group instant message sent by a user is received via an IM system.

This step is the same with step 301 of embodiment one.

In step 602, information including a group ID, a sender IM ID, sending time and message contents is obtained from the group instant message received from the IM system.

This step is the same with step 302 of embodiment one.

In step 603, an email address of each offline group member is obtained according to the group ID.

The group email converting apparatus searches group data stored in a system database according to the group ID obtained, and obtains IM IDs of all group members. The group email converting apparatus may further inquire the IM server to determine the online/offline state (including online, away, invisible, offline) of each group member, and queries user data stored in the system database according to the IM ID of each offline member to obtain the email address of each offline member.

In step 604, the group instant message is converted into a group email according to the email address.

This step is the same with step 304 of embodiment one. The group email converting apparatus generates the group email by using the information including the group ID, the sender IM ID, the sending time and the message contents obtained in step 602 as contents of the group email and by filling the email address of each offline group member obtained in step 603 into a recipient address field.

In step 605, the group email is sent to the email server.

This step is the same with step 305 of embodiment one. The group email converting apparatus sends the group email to an email server, an the email server sends the received group email to each offline member of the group.

In this embodiment, a group instant message in an IM system is converted into a group email of an email system. And online/offline states of the group members are inquired. The group email converted from the group instant message is sent only to the offline members. As such, the IM system is enabled to transfer information to the email system.

According to this embodiment, it is ensured that the group members can receive the group communication information. For example, although a group member is offline in the IM system, he/she may be online in his/her email system. Therefore, through sending the group communication information through the email system to the member who is offline in the IM system, delivery of group communication information is more satisfying.

Further, through sending the group email only to the offline members, the group member will not receive group communication information with the same contents repeatedly. For example, if a group member is using an IM client and an email client at the same time, he/she will receive both the group instant message and the group email according to the method shown in FIG. 4, whereas in the method shown in FIG. 6, he/she will not.

### Embodiment Three

Based on embodiment one, group emails received by a user in an email system will be collected and classified.

FIG. 7 is a schematic illustrating a group email converting apparatus in accordance with embodiment three of the present invention. As shown in FIG. 7, the apparatus obtains information including a group ID, a sender IM ID, sending time and message contents from each group instant messages received from an IM system, obtains an email address of each group member according to the group ID, converts the group instant messages into group emails, classifies and collects the group emails and sends the group emails classified and collected to an email server.

As shown in FIG. 7, based on embodiment one, the apparatus may include: a group message receiving unit 701, a group message parsing unit 702, a member information obtaining unit 703, a group email converting unit 704 and a group email sending unit 705.

The above units have the same functions as their counterpart units of embodiment one.

Taking into account the difference between the communication modes of IM systems and email systems, the apparatus may further include a group email classifying unit 706.

The group email classifying unit 706 is adapted to classify and collect group emails by category, set a session identifier for each email session, and add a session identifier to each group email according to the email session to which the group email belongs.

It should be noted that, all the group emails converted from the group instant messages of the same category in the IM system may form an email session. The group instant messages of the same category include all the group instant messages sent in a group chat session initiated by a user. Or, the email session can be regarded as an email group including an initial email and one or more responsive emails, or includes only one initial email.

Through the above processing, all the emails of the same email session have the same session identifier. Therefore, when receiving a group email, a user in the email system may view the group email according to the email session of the group email. In practice, the email client may be further equipped with a session displaying module, adapted to display multiple emails according to session identifiers and display all the emails in one email session arranged according to the receiving time of the emails. For example, an email session includes multiple emails. When displaying one of the emails, other emails in the email session which are received earlier than this email may be simultaneously displayed. This email display manner is similar to the manner for displaying instant messages in a chat window.

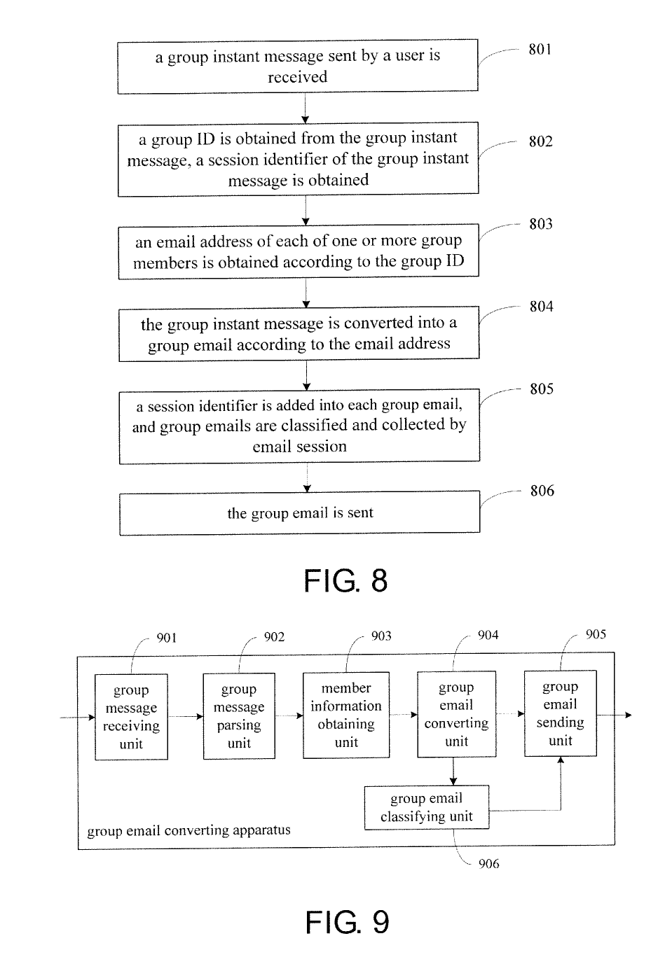

FIG. 8 is a flowchart illustrating a group email converting method in accordance with embodiment three of the present invention. As shown in FIG. 8, the method may include steps as follows.

In step 801, a group instant message sent by a user is received via an IM system.

In step 802, a group ID, a sender IM ID, sending time and message contents are obtained from the group instant message received from the IM system.

In step 803, an email address of each group member is obtained according to the group ID.

In step 804, the group instant message is converted into a group email according to the email address.

The above steps 801 to 804 are the same with steps 301 to 304 of embodiment one.

In step 805, group emails are classified and collected by email session, and a session identifier is added into each group email according to an email session to which the group email belongs.

An email session may include an initial email and one or more responsive emails, or only include one initial email.

In step 806, group emails classified and collected are sent to an email server.

Furthermore, the email system may classify group emails sent to the user into categories. The classifying performed by the email system may include: in an email client, storing group emails of the same category in a same folder (the folder may be generated by the system automatically or set by the user), or collecting historical emails into one email and save the email in the email server, etc.

Since the group email contains the session identifier which is used for identifying different email sessions and all the emails belong to the same email session have the same session identifier, the group emails of the same email session may be collected and displayed as folded items of an email list in the email client. That is to say, a title and receiving time, etc. of the initial email will be displayed in the email list, whereas the responsive emails will not be unfolded for display unless an unfolding icon (e.g. a “+” sign) in front of the initial email is clicked on.

In this embodiment, a group instant message of an IM system is converted into a group email of an email system. The group email converted from the group instant message is sent to the group members. And the group emails in the same category received by the user in the email system are classified. Therefore, the IM system is enabled to transfer information to the email system and it is convenient for the group user to search and browse group emails.

### Embodiment Four

Based on the technical features of embodiments two and three, this embodiment further inquires the online/offline state of group members, sends a group email converted from a group instant message only to offline members, and the group emails received by a user in an email system are classified by category.

FIG. 9 is a schematic diagram illustrating a group email converting apparatus in accordance with embodiment four of the present invention. As shown in FIG. 9, the apparatus receives a group instant message sent by a user of an IM system, obtains information including a group ID, a sender IM ID, sending time and message contents of the group instant message, obtains an email address of each offline group member, convert the group instant message into a group email, classifying group emails by category, and transmits the classified group emails to an email server.

As shown in FIG. 9, the apparatus may include: a group message receiving unit 901, a group message parsing unit 902, a member information obtaining unit 903, a group email converting unit 904, a group email sending unit 905 and a group email classifying unit 906.

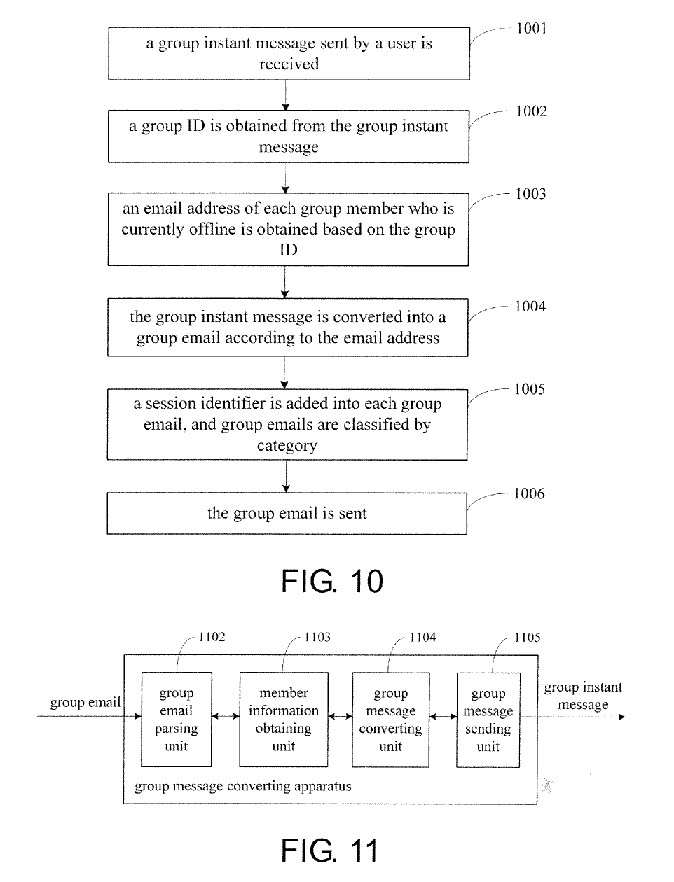

FIG. 10 is a flowchart illustrating a group email converting method in accordance with embodiment four of the present invention. As show in FIG. 10, the method may include steps as follows.

In step 1001, a group instant message sent by a user is received via an IM system.

In step 1002, information including a group ID, a sender IM ID, sending time and message contents of the group instant message is obtained from the group instant message received from the IM system.

In step 1003, an email address of each group member who is currently offline is obtained based on the group ID.

In step 1004, the group instant message is converted into a group email according to the email address.

In step 1005, the group email converting apparatus classifies group emails by category.

In step 1006, the classified group emails are sent to an email server.

In this embodiment, a group instant message of an IM system is converted into a group email of an email system. And online/offline states of the group members are inquired. The group email converted from the group instant message is sent only to offline members. And the group emails received by a user in the email system are classified by category. Therefore, an IM system is enabled to transfer information to an email system. The group members will not receive group communication information with the same contents repeatedly and it is convenient for group members to search and browse the group emails.

The above describes the group email converting apparatus and method provided by the embodiments of the present invention.

According to the apparatuses and methods provided by FIG. 1 to FIG. 10, suppose users A, B, C and D are members of a group. Users A, B and C have logged on via respective IM clients. User D does not log on via his IM client but logs on via an email client. User A sends a group instant message. The instant message is forwarded to the IM clients of users B and C through an IM server. Therefore, users B and C can receive the group instant message. Meanwhile, through the group message converting apparatus provided by the embodiments of the present invention, the group instant message is converted into a group email and sent. Therefore, user D can learn the contents of the group instant message sent by user A through the email client.

In order to enable an email system to transfer information to an IM system, embodiments of the present invention provide a group message converting apparatus and method.

FIG. 11 is a schematic illustrating a group message converting apparatus in accordance with an embodiment of the present invention. As shown in FIG. 11, the apparatus obtains from a group email a group identifier of a group email received from an email system associated with an application system, obtains an IM ID of each group member based on the group identifier, converts the group email into a group instant message and transmits the group instant message.

As shown in FIG. 11, the apparatus may include: a group email parsing unit 1102, a member information obtaining unit 1103, a group message converting unit 1104 and a group message sending unit 1105.

The group email parsing unit 1102 is adapted to obtain a group identifier of a group email.

The member information obtaining unit 1103 is adapted to obtain an IM ID of each group member according to the group identifier obtained by the group email parsing unit 1102.

The group message converting unit 1104 is adapted to convert the group email into a group instant message according to the IM ID obtained by the member information obtaining unit 1103.

The group message sending unit 1105 is adapted to send the group instant message generated by the group message converting unit 1104.

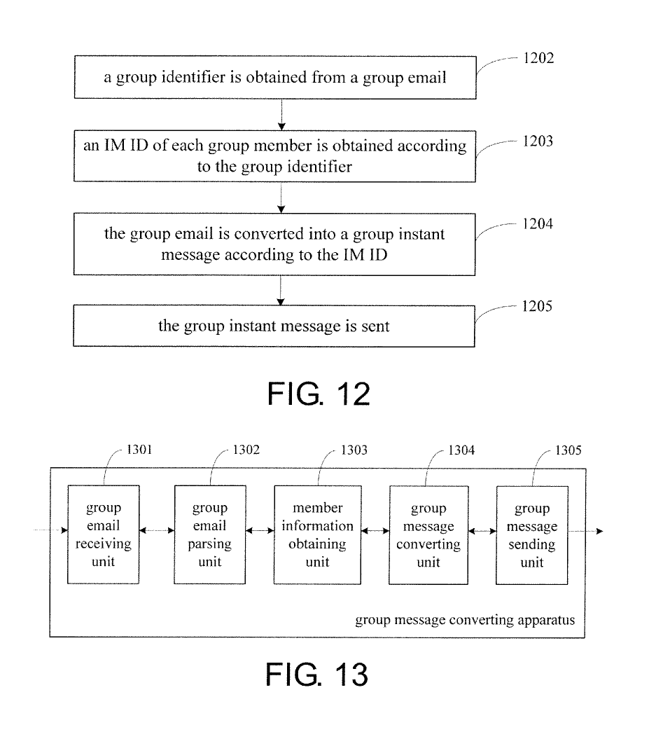

FIG. 12 is a flowchart illustrating a group message converting method in accordance with an embodiment of the present invention. As shown in FIG. 12, the method may include steps as follows.

In step 1202, a group identifier of a group email is obtained.

In step 1203, an IM ID of each group member is obtained according to the group identifier.

In step 1204, the group email is converted into a group instant message according to the IM ID.

In step 1205, the group instant message is sent.

Hereinafter, the group message converting apparatus and method will be described in detail with reference to embodiments.

### Embodiment Five

FIG. 13 is a schematic illustrating a group message converting apparatus in accordance with an embodiment of the present invention. As shown in FIG. 13, the apparatus receives a group email sent by a user of an email system which is associated with an application system (such as an IM system, an online game system, an online forum system, etc.), obtains at least one of a group ID of the group email, a sender email address, a title and sending time of the group email, and a hyperlink of the group email in a mailbox of each recipient, obtains an IM ID of each group member according to the group ID, converts the group email into a group instant message, and transmits the group instant message to an IM server.

As shown in FIG. 13, the apparatus may include: a group email receiving unit 1301, a group email parsing unit 1302, a member information obtaining unit 1303, a group message converting unit 1304 and a group message sending unit 1305.

The group email receiving unit 1301 is adapted to receive a group email sent by the user of an email system which is associated with an application system (such as an IM system, an online game system, an online forum system, etc.).

The group email parsing unit 1302 is adapted to parse the group email received by the group email receiving unit 1301, obtain information of the group email including a group ID, a sender email address, a title and sending time of the group email, and a hyperlink of the group email in the mailbox of each user.

The member information obtaining unit 1303 is adapted to query a system database which stores group data according to the group ID obtained by the group email parsing unit 1302, obtain an IM ID of each group member, query a system database which stores user data according to the sender email address obtained by the group email parsing unit 1302 to obtain IM user information (e.g. nickname, etc.) of the group email sender.

The group message converting unit 1304 is adapted to form a group instant message by taking the IM ID of each group member obtained by the member information obtaining unit 1303 as a recipient ID of the instant message, taking the title, sending time of the group email and the hyperlink of the group email in the mailbox of each recipient obtained by the group email parsing unit 1302 and the nickname of the group email sender obtained by the member information obtaining unit 1303 as contents of the instant message.

The group message sending unit 1305 is adapted to transmit the group instant message generated by the group message converting unit 1304 to an IM server. The IM server is adapted to send the group instant message to each user in the group according to the recipient ID.

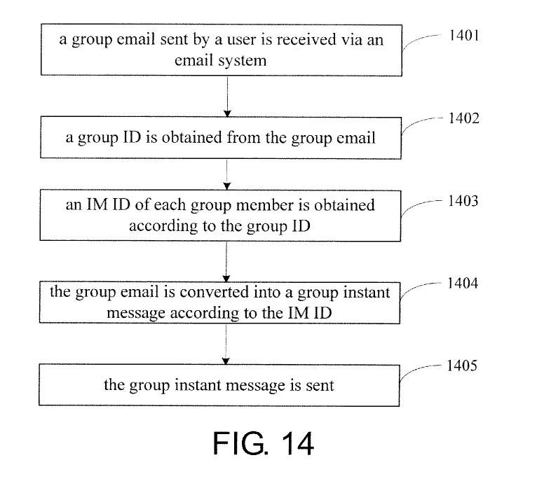

FIG. 14 is a flowchart illustrating a group message converting method in accordance with embodiment five of the present invention. As shown in FIG. 14, the method may include steps as follows.

In step 1401, a group email sent by a user is received via an email system.

In an email system associated with an application system (such as an IM system, an online game system, an online forum system, etc.), a user in a group sends a group email to the group. An email server transmits the group email to other users in the group. After determining that the email is a group email, the email server may classify group emails, e.g., put the group email in a same folder of each group member (the folder may be generated by the system automatically or set by the user), or collect historical emails into one email and store the email in the email server. The operations are similar to those in existing email systems and will not be described further herein. Hereinafter, the email server transmits the group email to the group message converting apparatus provided by this embodiment of the present invention.

In step 1402, a group ID of the group email, a sender email address, a title and sending time of the group email, and a hyperlink of the group email in a mailbox of each recipient is obtained from the group email sent by the email system.

The group message converting apparatus receives the group email sent by the email system, parses the group email, and obtains the group ID, the sender email address, the title and the sending time of the group email and the hyperlink of the group email in the mailbox of each recipient from the group email.

In step 1403, a system database which stores group data is queried according to the group ID obtained by the group email parsing unit to obtain an IM ID of each group member.

The group message converting apparatus queries the system database which stores the group data according to the group ID to obtain the IM ID of each group member. The group message converting apparatus further queries a system database which stores user data according to the sender email address obtained by the group email parsing unit to obtain IM user information, e.g. nickname, of the email sender.

In step 1404, the group email is converted into a group instant message.

The group message converting apparatus forms a group instant message by taking the group ID, the sender email address, the title, the sending time of the group email, and the hyperlink of the group email in the mailbox of each recipient obtained in step 1402 and the nickname of the sender of the group email obtained in step 1403 as contents of the instant message and takes the IM IDs of all the group members obtained in step 1403 as recipient IDs of the instant message.

In step 1405, the group instant message is sent to an IM server.

The group message converting apparatus transmits the group instant message to an IM server. The IM server then transmits the group instant message to each user in the group.

When a user in a group of an IM system is online and has a group chat window open, once a group email belonging to the group arrives, an instant message converted from the group email will be displayed in the group chat window in real time.

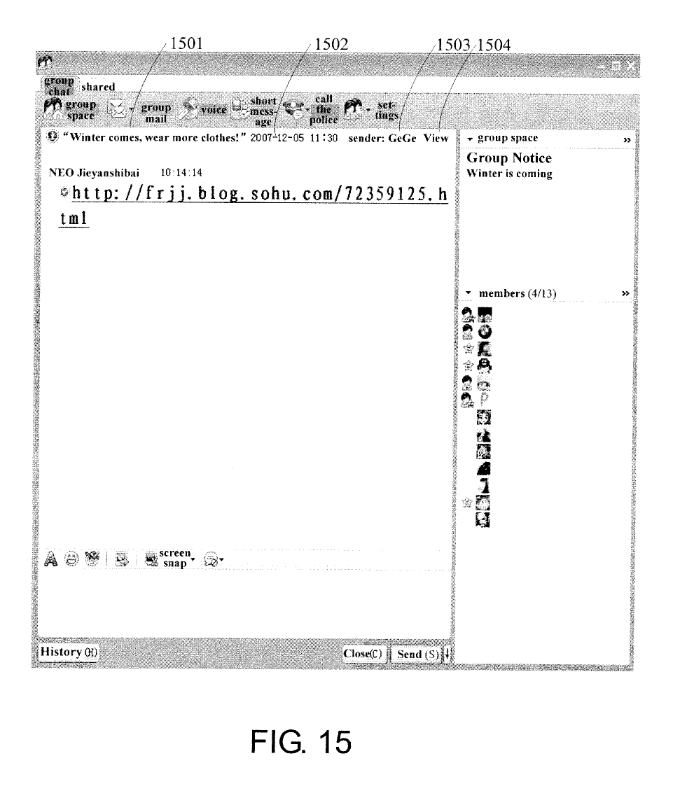

FIG. 15 is a schematic illustrating a group instant message converted using the method shown in FIG. 14. As shown in FIG. 15, the group instant message may include: a title of the group email 1501, sending time 1502, a sender nickname 1503 and group email viewing entrance 1504, i.e. a hyperlink of the group email in the mailbox of each recipient.

After receiving a notification of receipt of the instant message converted from the group email, a user may know a summary of the group email based on the title 1501 displayed in the instant message, and can click on the viewing entrance 1504 to enter the email system and read the group email.

If the user is offline, once a group email arrives, the IM system stores the instant message converted from the group email. When the user is online and opens the group chat window, he/she can read the instant message from the IM server when prompted and have the instant message displayed in the group chat window.

In this embodiment, a group email in the email system is converted into a group instant message in the IM system. The group instant message converted from the group email is sent to the group members. Therefore, when someone sends an email to the group members, the group members may immediately obtain a notification. Thus, the email system is enabled to transfer information to the IM system.

The above describes a group message converting apparatus and method provided by embodiments of the present invention.

In order to enable information exchange between an email system and an IM system, embodiments of the present invention also provide a group message exchanging system.

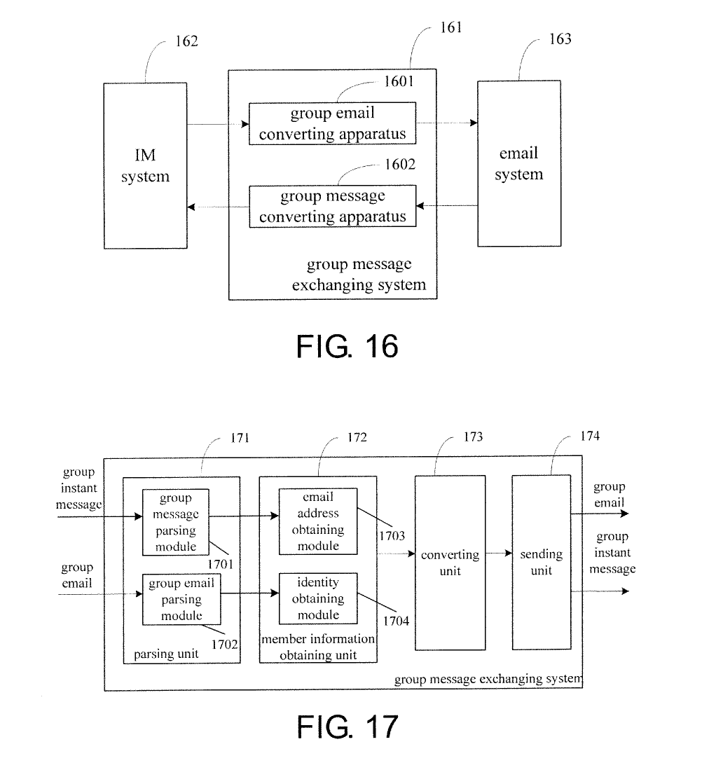

FIG. 16 illustrates a structure of a group message exchanging network in accordance with an embodiment of the present invention. As shown in FIG. 16, the network may include: a group message exchanging system 161, an IM system 162 and an email system 163. The group message exchanging system 161 is adapted to receive a group instant message from the IM system 162, convert the group instant message into a group email and transmit the group email to the email system 163, or receive a group email from the email system 163, convert the group email into a group instant message and transmit the group instant message to the IM system 162. As shown in FIG. 16, the group message exchanging system 161 may include: a group email converting apparatus 1601 and a group message converting apparatus 1602.

The group email converting apparatus 1601 may be any of the group email converting apparatuses provided by embodiments one to four of the present invention.

The group message converting apparatus 1602 may be the group message converting apparatus provided by embodiment five of the present invention.

In the IM system, a user in a group transmits an instant message to the group. The IM server establishes a connection between the user and other online users of the group using a direct connection method or a server forwarding method, transmits the instant message to the other online users in the group, and stores the message in the IM server for offline users in the group. At the same time, the IM server transmits the instant message to the group message exchanging system of this embodiment of the present invention. The group message exchanging system obtains, from the group instant message sent by the IM system, information such as a group ID, a sender IM ID, sending time and message contents of the instant message, converts the group instant message into a group email and transmits the group email to the email server. The email server transmits the group email to each user in the group.

The group message exchanging system may be further adapted to transmit the group email converted from the group instant message to only offline members and classify group emails received by a user in the email system by category.

Therefore, when a user can log on only via an email client and cannot log on via an IM client, the user can still obtain group chat information of the IM system.

In the email system, the user may choose to reply to a group email converted from a group instant message or to create a new group email to be sent to the group. The email server transmits the group email to the other users in the group. At the same time, the email server sends the group email to the group message exchanging system provided by this embodiment of the present invention. The group message exchanging system obtains, from the group email sent by the email system, information such as a group ID, a sender email address, a title, sending time of the group email, and a hyperlink of the group email in the mailbox of each recipient, queries a system database which stores group data according to the group ID to obtain IM IDs of all group members, queries a system database which stores user data according to the sender email address obtained by the group email parsing unit to obtain the IM user information, i.e. a nickname, of the sender of the group email, converts the group email into a group instant message and sends the group instant message to the IM server. The IM server sends the group instant message to each user in the group. In the IM system, when a user in a group is online and has a group chat window open, once an email of the group arrives, an instant message converted from the group email is displayed in the group chat window in real-time. If the user is offline, once a group email arrives, the IM system stores the instant message converted from the group email so that when the user is online and opens a group chat window, he/she may read the instant message from an IM server and have the instant message displayed in the group chat window.

Therefore, when a user chats with other group members in a group chat window in the IM system, if someone sends an email to the group members, the user can obtain a notification of the arrival of the email immediately. Then, the user may view the email.

FIG. 17 illustrates an internal structure of a group message exchanging system in accordance with an embodiment of the present invention. As shown in FIG. 17, the system may include: a parsing unit 171, a member information obtaining unit 172, a converting unit 173 and a sending unit 174.

The parsing unit is adapted to obtain a group identifier from group communication information. The parsing unit 171 may further include: a group message parsing module 1701 and a group email parsing module 1702. The group message parsing module 1701 has functions similar to that of the group message parsing unit in FIG. 1, and the group email parsing module 1702 has functions similar to that of the group email parsing unit in FIG. 11.

The member information obtaining unit 172 is adapted to obtain an IM ID or an email address of each group member according to a group identifier. The member information obtaining unit 172 may further include: an email address obtaining module 1703 and an identity obtaining module 1704.

The email address obtaining module 1703 is adapted to obtain an email address of at least one group member according to a group identifier obtained. The email address obtaining module 1703 has functions similar to that of the member information obtaining unit 103 shown in FIG. 1.

The identity obtaining module 1704 is adapted to obtain an IM identifier of at least one group member according to a group identifier obtained. The identity obtaining module 1704 has functions similar to that of the member information obtaining unit 1103 shown in FIG. 11.

The converting unit 173 is adapted to convert the group communication information from one type to another type. The conversion includes setting a recipient identifier and forming communication information contents. The recipient identifier may be a recipient address or a recipient ID. When processing a group instant message, the converting unit 173 has functions similar to that of the group email converting unit 104. When processing a group email, the converting unit 173 has functions similar to that of the group message converting unit 1104.

The sending unit 174 is adapted to send the converted group communication information.

In view of the above, the system can convert a group instant message of an IM system into a group email of an email system and send the group email converted from the group instant message to the group members, and/or convert a group email of the email system into a group instant message of the IM system and send the group instant message converted from the group email to the group members. Thus, the email system and the IM system are enabled to exchange information with each other.

The foregoing descriptions are only preferred embodiments of this invention and are not for use in limiting the protection scope thereof. Any changes and modifications can be made by those skilled in the art without departing from the principle of this invention and therefore should be covered within the protection scope as set by the appended claims.

1. An apparatus for converting group message, comprising:
a parsing unit, adapted to obtain a group identifier of group communication information of a first type;
a member information obtaining unit, adapted to obtain, according to the group identifier obtained, an address of each of at least one group member of a group for communicating group communication information of a second type; and
a converting unit, adapted to convert the group communication information of the first type into group communication information of the second type according to the address for communicating group communication information of the second type.

2. The apparatus of claim 1, further comprising:
a receiving unit, adapted to receive the group communication information of the first type sent by a user and provide the group communication information of the first type to the parsing unit; and
a sending unit, adapted to send the group communication information of the second type generated by the converting unit.

3. The apparatus of claim 1, wherein the parsing unit is adapted to obtain a group identifier from a group instant message; and
the member information obtaining unit is adapted to search group data and user data stored in a system database according to the group identifier to obtain an email address of each of the at least one group member.

4. The apparatus of claim 3, wherein the member information obtaining unit is further adapted to determine whether a group member of the group is online in an instant messaging system and obtain an email address of each group member which is offline.

5. The apparatus of claim 3, wherein the parsing unit is further adapted to obtain at least one of a sender instant messaging (IM) identifier, sending time and message contents from the group instant message received; and
the converting unit is further adapted to form a group email with one or more recipients by taking the email address of each group member as a recipient address and taking at least one of the group identifier, the sender IM identifier, the sending time and the message content as contents of the group email.

6. The apparatus of claim 3, further comprising:
a group email classifying unit, adapted to classify converted group emails by category, set a session identifier for each email session and add a session identifier for each of the group emails according to an email session to which the group email belongs.

7. The apparatus of claim 1, wherein
the parsing unit is adapted to obtain a group identifier from a group email;
the member information obtaining unit is adapted to obtain an IM identifier of each of at least one group member of the group according to the group identifier obtained.

8. The apparatus of claim 7, wherein
the parsing unit is further adapted to obtain from the received group email at least one of a sender email address, a title, sending time of the group email, and a hyperlink of the group email in a mailbox of each of one or more recipients of the group email; and
the converting unit is adapted to form a group instant message with one or more recipients by taking the IM identifier obtained as a recipient identifier of a group instant message and taking at least one of the group identifier, the sender email address, the title, the sending time of the group email, and the hyperlink of the group email in the mailbox of each recipient as contents of the group instant message.

9. A method for converting group message, comprising:
obtaining a group identifier of received group communication information of a first type;
obtaining, according to the group identifier, an address of each of at least one group member of a group for communicating group communication information of a second type; and
converting the group communication information of the first type into group communication information of the second type according to the address for communicating group communication information of the second type and sending the converted group communication information of the second type.

10. The method of claim 9, wherein the group communication information of the first type is a group instant message and the group communication information of the second type is a group email.

11. The method of claim 10, wherein the obtaining according to the group identifier the address of each of at least one member of the group for communicating communication information of the second type comprises:
obtaining an instant messaging (IM) identifier of each of the at least one group member from group data stored in a system database according to the group identifier, and
obtaining an email address of each of the at least one group member from user data stored in the system database according to the IM identifier of the group member.

12. The method of claim 11, wherein the obtaining according to the group identifier the address of each of the at least one group member for communicating the group communication information of the second type comprises:
obtaining an email address of each group member which is currently offline according to the group identifier.

13. The method of claim 11, further comprising:
obtaining, from the group instant message received, at least one of a sender IM identifier, a sending time and a instant message content for use as contents of the group email.

14. The method of claim 13, wherein the converting the group communication information of the first type into the group communication information of the second type comprises:
taking the email address of each of the at least one group member obtained as a recipient address, and combining the recipient address and the contents of the group email to form the group email with one or more recipients.

15. The method of claim 9, wherein the group communication information of the first type is a group email and the group communication information of the second type is a group instant message.

16. The method of claim 15, wherein the obtaining according to the group identifier the address of each of the at least one group member for communicating the group communication information of the second type comprises:
obtaining an IM identifier of each of the at least one group member according to the group identifier.

17. The method of claim 16, further comprising:
obtaining, from the group email received, at least one of a sender email address, a title, sending time of the group email and a hyperlink of the group email in a mailbox of each recipient of the group email for use as contents of the group instant message;
wherein the converting the group communication information of the first type into the group communication information of the second type comprises:
taking the IM identifier of each of the at least one group member obtained as a recipient identifier of the group instant message and combining the recipient identifier and the contents of the group instant message to form the group instant message with one or more recipients.

18. A group message exchanging system, comprising:
a group email converting apparatus, adapted to receive a first group instant message and convert the first group instant message into a first group email and send the first group email; and
a group message converting apparatus, adapted to receive a second group email, convert the second group email into a second group instant message and send the second group instant message.

19. The system of claim 18, wherein the group email converting apparatus comprises:
a group message parsing unit, adapted to obtain a group identifier of the first group instant message;
an email address obtaining unit, adapted to obtain an email address of each of at least one group member of a group according to the group identifier; and
a group email converting unit, adapted to convert the first group instant message into the first group email according to the email address.

20. The system of claim 18, wherein the group message converting apparatus comprises:
a group email parsing unit, adapted to obtain a group identifier from the second group email;
an identity obtaining unit, adapted to obtain an IM identifier of each of at least one group member of a group according to the group identifier obtained; and
a group message converting unit, adapted to convert the second group email into the second group instant message according to the IM identifier.
